(19) United States
(12) Patent Application Publication
(10) Pub. No.: US 2023/0260012 A1
(43) Pub. Date: Aug. 17, 2023

(54) REAL-TIME TRANSACTION AND MARKETING MANAGEMENT SYSTEM AND METHOD FOR THE SAME

(71) Applicant: WEI-PIN LIN, Taipei City (TW)

(72) Inventor: WEI-PIN LIN, Taipei City (TW)

(21) Appl. No.: 18/105,802

(22) Filed: Feb. 3, 2023

(30) Foreign Application Priority Data
Feb. 17, 2022 (TW) 111105788

(51) Int. Cl. G06Q 30/0601

(52) U.S. Cl. CPC G06Q 30/0643; G06F 3/04817

(57) ABSTRACT

A real-time transaction and marketing management system and a method for the same is introduced herein, for usage with a specific social network platform, which utilize at least one image-capturing device to capture live image streaming data of a physical-trading place where a specific physical good is being exhibited, and a remote webserver to produce a number of icons, respectively indicative of marketing information relevant to the specific physical good, on a basis of the live image streaming data, thereby enabling a purchaser/vendor terminal displaying unit to display a dedicated managing webpage thereon which contains an instant physical-trading scene where the icons are inserted for clicking. With the system, marketing steps, good information and client data, of the physical-trading place can be electronization-managed, for accomplishing click-and-mortar transactions, and raising a deal-making rate and a transaction confidence level.

### FIELD OF THE INVENTION

The present invention relates to a computing network technical field where E-commerce transactions are manipulated with usage of live image streaming data in constructing instant physical-trading scene, and more particularly, to a real-time transaction and marketing management system and a method for the same, which are implemented on a basis of a specific social network platform.

### BACKGROUND OF THE INVENTION

Recently, since traditional physical-trading places, such as traditional markets, farmers' marketplaces, brick-and-mortar stores, warehouses, orchards, rangelands, ranches, factories, market stalls and so forth, were usually restricted through their existing traditionally-marketing implements, channels or methods, by which their traditional trades were face-to-face carried out in persons. These were developed overly backward and homogeneous, resulting in incapability of affording useful and sufficient marketing information to have accurate estimates for the consumers (namely the purchasers). Besides that, for the vendors, due to a restriction of a local limited physical space thereof, every physical transaction accomplished in these traditional physical-trading places is quite time-consuming, laborious, incapable of one-time instantly completing all of the physical-trading steps, and also incapable of efficiently spreading new customers. Thus, this causes the probabilities, of making marketing efficiency and trading success, very low.

Furthermore, within various kinds of those existing social network platforms, such as Facebook, Line, B2B/B2C, E-commerce transaction platforms and so forth, a variety of E-commerce transactions were frequently flooded with many risk issues, such as scams incurred from one-page type advertising webpages, delivery delays or expired goods. Even though those existing social network platforms or the E-commerce transaction platforms have provided channels, to complain or return goods, for the consumers. All of the channels were used just at that time after transaction disputes happened therein. However, it is in practice comprehensible that at this time the consumers lost lots of money or were incapable of rapidly achieving the desired goods. Briefly, those existing channels, to complain or return goods, were incapable of providing the consumers with a mechanism of effectively preventing said risks in advance, before the consumers carried out each transaction. The aforementioned risk issues in association with the scams or delivery delays, for example, include but not limited to that, the physical good the consumer acquires is different from the online-marketing good, the physical good the consumer acquires has defects, the consumer is informed of an insufficient inventory to instant supply specific physical good after sending an order, and so forth. These issues all are incapable of being instantly fed back to the consumer. Besides, on those existing social network platforms, such as Facebook, LINE, TWITTER, GOOGLE+, WhatsApp, WeChat and so forth, the ‘Q&A’ webpages associated with the transactions of the specific physical good or online-marketing goods are always integrated with a huge mass of early-and-accumulatively old information (containing texts, chats, and audio/video information), and particularly, with sponsored contents. This would not only make the transaction-webpage content easily chaotic but also inconvenient for the consumers' manipulations to seek desired answers thereon.

If the aforementioned traditional physical-trading places, such as traditional markets, farmers' marketplaces, brick-and-mortar stores, warehouses, orchards, rangelands, ranches, market stalls and so forth, intend extra building up their dedicated E-commerce transaction websites by themselves, their built-up hardware costs would be over costly, and then their webpage contents still need to be continuously maintained for the respective launched goods, thereby making their selling expenses being increased. Another approach is that, if these traditional physical-trading places hand over or launch their goods outside to the aforementioned existing social network platforms or E-commerce transaction platforms for selling and marketing. The same risk issues as aforementioned, including scams, delivery delays or expired goods, would still happen. For the consumers, the aforementioned drawbacks cannot yet be resolved.

Hence, it is essential to provide a real-time transaction and marketing management system and/or a method for the same, for resolving the various kinds of drawbacks as aforementioned incurred in these prior arts.

### SUMMARY OF THE INVENTION

To resolve the afore-mentioned technical problems of the prior arts, a primary objective of the present invention is to provide a real-time transaction and marketing management system and a method for the same, which provide respective distant purchaser terminals (namely distant consumers) with live image streaming data of instant physical-trading scenes captured from a variety of existing traditional physical-trading places (e.g. the traditional markets, farmers' marketplaces, brick-and-mortar stores, warehouses, orchards, tea plantations, rangelands, ranches, factories, market stalls and so forth), only by way of a remote webserver of a specific social network platform such as a third party terminal. Accordingly, a function that integrates both of an instantly high efficiency, brought from online E-commerce transaction, and a higher authenticity/assurance, brought from off-line exhibiting the physical goods in those existing traditional physical-trading places, can be achieved. This could make the consumers obtaining an accurately estimating basis before sending an order, thereby being capable of effectively avoiding the aforementioned risk issues, such as scams, delivery delays or expired goods, incurred in these prior arts. For example, the aforementioned risk issues, include but not limited to that, the physical good the consumer acquires is different from the online-marketing good, the physical good the consumer acquires has defects, the consumer is informed of an insufficient inventory to supply a specific physical good after sending an order, and so forth.

Besides, another objective of the present invention is to provide a real-time transaction and marketing management system and a method for the same, where a remote webserver (such as a transaction-processing backstage) is utilized to completely accomplish an electronized management for operation and marketing steps, good information and the client data, of those existing physical-trading places (such as the traditional transaction markets, farmers' marketplace, brick-and-mortar stores, whole-sale or retail-sale warehouses, orchards, tea plantations, rangelands, ranches, factories, market stalls and so forth). It is capable of instantly, directly and efficiently carrying out click-and-mortar transactions, to avoid multilevel distributors (e.g. a wholesale distributor and/or an intermediary distributor), which appear in between both the purchaser terminals and the vendor terminals, joining their profit distribution. Consequently, the profits of the vendor terminals and the benefits of the purchaser terminals all can be raised.

Besides, another objective of the present invention is to provide a real-time transaction and marketing management system and a method for the same, through a specific social network platform, which are capable of providing those existing traditional physical-trading places with spreads of their new customers and business opportunities, but without need of extra building up their E-commerce transaction platforms by themselves. Therefore, the built-up hardware costs or the maintaining/updating cost of the webpage content can be decreased.

Besides, another objective of the present invention is to provide a real-time transaction and marketing management system and a method for the same, which utilize at least one image-capturing device to capture live image streaming data of a physical-trading place where a specific physical good is being exhibited, thereby enabling a purchaser/vendor terminal displaying unit to display a dedicated managing webpage thereon which contains an instant physical-trading scene constructed of the live image streaming data. The instant physical-trading scene in-sight stream-renders the corresponding physical-trading place, the specific physical good and a number of icons, by a way that the icons are inserted into the instant physical-trading scene and pointed to the specific physical good. The icons are respectively indicative of a number of marketing information relevant to the specific physical good. The relevant marketing information includes price information relevant to the specific physical good. In addition, the icons can comprise an immediate checkout icon click-linked to a checkout modular, and a webpage-skipping icon click-linked to another webpage, which specifies other marketing information relevant to the specific physical good. Therefore, the inserted icons are capable of readily simplifying operation steps for E-commerce transactions of the specific social network platform, thereby facilitating a high deal-making rate for the respective transactions.

To resolve the aforementioned technical drawbacks of these prior arts, a preferred embodiment according to the present invention adopts the following technical solution that provides a real-time transaction and marketing management system for usage with a specific social network platform linked to a network configuration. The real-time transaction and marketing management system comprises: a remote webserver dedicated to the specific social network platform, at least one purchaser terminal and at least one image-capturing device. The remote webserver has a server processor, a management unit and a client database. The at least one purchaser terminal is electronically connected to the remote webserver through the network configuration and has a purchaser terminal processor, an executive modular dedicated to the specific social network platform and providing a network operational interface, and a purchaser terminal displaying unit. The at least one image-capturing device is configured to capture live image streaming data of a physical-trading place where a specific physical good is being exhibited, and then to transmit the live image streaming data in a restrictive way only to the remote webserver through the network configuration, wherein the management unit of the remote webserver produces a number of icons, respectively indicative of marketing information relevant to the specific physical good, on a basis of the live image streaming data containing the specific physical good, and then makes both the live image streaming data and the icons being inserted into a webpage-format file, in a way of creating a modified webpage-format file to be saved within the client database. After the network operational interface of the executive modular of the at least one purchaser terminal sends a purchaser request message to the remote webserver, the management unit of the remote webserver produces a response message of making the modified webpage-format file being transmitted to the at least one purchaser terminal, whereby after the at least one purchaser terminal executes the modified webpage-format file by the network operational interface of the executive modular thereof, the purchaser terminal displaying unit is enabled to display a first managing webpage thereon which contains an instant physical-trading scene constructed of the live image streaming data. The instant physical-trading scene in-sight stream-renders the corresponding physical-trading place, the specific physical good and the icons, by a way that the icons are inserted into the instant physical-trading scene and pointed to the specific physical good. By the network operational interface of the executive modular of the at least one purchaser terminal, activating one of the icons to produce a request message, of making a quick transaction of the specific physical good, which is sent to the remote webserver, the management unit of the remote webserver is enabled to produce a real-time network marketing information relevant to the specific physical good, and then to make the real-time network marketing information being saved within the client database.

In a preferred embodiment according to the present invention, the remote webserver launches a distant control on the at least one image-capturing device through the network configuration, thereby making the at least one image-capturing device producing the live image streaming data of the corresponding physical-trading place.

In a preferred embodiment according to the present invention, after the at least one purchaser terminal executes the modified webpage-format file, on a basis of an access information dedicated for entry of the at least one purchaser terminal, by the network operational interface of the executive modular, the purchaser terminal displaying unit is enabled to display the first managing webpage thereon.

In a preferred embodiment according to the present invention, the real-time transaction and marketing management system further comprises at least one vendor terminal which is located at the physical-trading place and electronically connected to the remote webserver through the network configuration, and the at least one vendor terminal has a vendor terminal processor, an executive modular, a vendor terminal displaying unit and the at least one image-capturing device, wherein by way of controlling of the executive modular of the at least one vendor terminal, the at least one image-capturing device captures the live image streaming data of the corresponding physical-trading place and then makes the live image streaming data being transmitted to the remote webserver through the at least one vendor terminal and the network configuration, and after the network operational interface of the executive modular of the at least one vendor terminal sends a vendor request message to the remote webserver, the management unit of the remote webserver produces a response message of making the modified webpage-format file being transmitted to the at least one vendor terminal, wherein after the network operational interface of the executive modular of the at least one vendor terminal executes the modified webpage-format file, the vendor terminal displaying unit is enabled to display a second managing webpage thereon which contains the instant physical-trading scene, and after the remote webserver produces the real-time network marketing information, the remote webserver transmits the real-time network marketing information to the at least one vendor terminal, in a way of making the vendor terminal displaying unit or the second managing webpage in-sight displaying the real-time network marketing information.

In a preferred embodiment according to the present invention, after the network operational interface of the executive modular of the at least one vendor terminal executes the modified webpage-format file, on a basis of an access information dedicated for entry of the at least one vendor terminal, the vendor terminal displaying unit is enabled to display the second managing webpage thereon.

In a preferred embodiment according to the present invention, the at least one vendor terminal correspondingly produces a real-time physical-marketing information, dependent on a real-time physical-marketing situation of the specific physical good at the physical-trading place, to make the real-time physical-marketing information being transmitted to the remote webserver through the network configuration, in a way that the remote webserver updates the relevant marketing information, which are respectively indicative in the icons, on a basis of the real-time physical-marketing information and/or the real-time network marketing information, and thereby correspondingly updates the modified webpage-format file.

In a preferred embodiment according to the present invention, the remote webserver further has an image-and-icon processing modular which is configured to produce/update the icons respectively indicative of the relevant marketing information for the specific physical good, and the relevant marketing information contains price information relevant to the specific physical good, and the icons comprise an immediate checkout icon click-linked to a checkout modular, and a webpage-skipping icon click-linked to another webpage which specifies other marketing information relevant to the specific physical good.

In a preferred embodiment according to the present invention, the icons comprise an icon indicative of an inventory quantity of the specific physical good, and/or the instant physical-trading scene in-sight stream-renders a quantity of the specific physical good.

In the real-time transaction and marketing management system according to a preferred embodiment of the present invention, the instant physical-trading scene comprises at least one frame that renders a physical trade being face-to-face carried out in persons.

Besides, another preferred embodiment according to the present invention further adopts the following technical solution which provides a real-time transaction and marketing management method, applied with a specific social network platform linked to a network configuration, comprising the following steps of:

at least one image-capturing device capturing live image streaming data of a physical-trading place where a specific physical good is being exhibited, and then transmitting the live image streaming data in a restrictive way only to a remote webserver dedicated to the specific social network platform, through the network configuration;

next, a management unit of the remote webserver, producing a number of icons, respectively indicative of marketing information relevant to the specific physical good, on a basis of the live image streaming data containing the specific physical good, and then making both the live image streaming data and the icons being inserted into a webpage-format file, in a way of creating a modified webpage-format file to be saved within a client database of the remote webserver;

next, after a network operational interface, contained in an executive modular of at least one purchaser terminal, sends a purchaser request message to the remote webserver, the management unit of the remote webserver producing a response message of making the modified webpage-format file being transmitted to the at least one purchaser terminal;

next, after the at least one purchaser terminal executes the modified webpage-format file by the network operational interface of the executive modular thereof, enabling a purchaser terminal displaying unit of the at least one purchaser terminal to display a first managing webpage thereon which contains an instant physical-trading scene constructed of the live image streaming data and in-sight stream-rendering the corresponding physical-trading place, the specific physical good and the icons, by a way that the icons are inserted into the instant physical-trading scene and pointed to the specific physical good; and

next, by the network operational interface of the executive modular of the at least one purchaser terminal, activating one of the icons to produce a request message, of making a quick transaction of the specific physical good, which is sent to the remote webserver, enabling the management unit of the remote webserver to produce a real-time network marketing information relevant to the specific physical good, and then to make the real-time network marketing information being saved within the client database.

In a preferred embodiment according to the present invention, the real-time transaction and marketing management method further comprises: by at least one vendor terminal, which is located at the physical-trading place, controlling the at least one image-capturing device, enabling the at least one image-capturing device to capture the live image streaming data of the physical-trading place, and then to make the live image streaming data being transmitted to the remote webserver, through the at least one vendor terminal and the network configuration;

next, after a network operational interface of an executive modular disposed in the at least one vendor terminal sends a vendor request message to the remote webserver, the management unit of the remote webserver producing a response message of making the modified webpage-format file being transmitted to the at least one vendor terminal;

next, after the network operational interface of the executive modular of the at least one vendor terminal executes the modified webpage-format file, enabling a vendor terminal displaying unit of the at least one vendor terminal to display a second managing webpage thereon which contains the instant physical-trading scene; and

next, after the remote webserver produces the real-time network marketing information, the remote webserver transmitting the real-time network marketing information to the at least one vendor terminal, in a way of making the vendor terminal displaying unit or the second managing webpage in-sight displaying the real-time network marketing information thereon.

In a preferred embodiment according to the present invention, the real-time transaction and marketing management method further comprises:

by the at least one vendor terminal producing a real-time physical-marketing information, dependent on a real-time physical-marketing situation of the specific physical good at the physical-trading place, and then making the real-time physical-marketing information being transmitted to the remote webserver through the network configuration, the remote webserver updating the relevant marketing information, which are respectively indicative in the icons, on a basis of the real-time physical-marketing information and/or the real-time network marketing information, thereby updating the modified webpage-format file.

In the real-time transaction and marketing management method according to a preferred embodiment of the present invention, the instant physical-trading scene comprises at least one frame of rendering a physical trade that is being face-to-face carried out in persons.

In comparison with the prior arts, the present invention could bring the following beneficial effects that: (1) the real-time transaction and marketing management system and the method for the same, according to the present invention, can integrate an instant high efficiency of the virtual E-commerce transaction with a higher authenticity/assurance function provided from those existing physical-trading places. This could lead the distant consumers to achieve an accurately estimating basis and a higher confidence level before the distant consumers send an online order, thereby being capable of effectively avoiding scams, delivery delay, expired goods, or the aforementioned risk issues incurred in these prior arts, for example, including but not limited to, a physical good that the consumer acquires having differences from an online-marketing good that the same consumer online-orders, a physical good that the consumer acquires having defects, receiving an insufficient-inventory notice after the consumer sends an order, and so forth. According to the present invention, the instant physical-trading scenes constructed of live image streaming data, image-captured from those existing physical-trading places (such as traditional markets, farmers' marketplace, brick-and-mortar stores, warehouses, orchards, tea plantations, rangelands, ranches, factories, market stalls and so forth) could be instantly provided for at least one purchaser terminal (namely a distant consumer) which is located at a distant region. With utilization of the live image streaming data of those existing physical-trading place, such an instant physical-trading scene could concretely render a physical trade which is being face-to-face carried out in persons at an existing physical-trading place, and also could be simultaneously broadcasted to the at least one purchaser terminal for his/her watch and reference. In addition that the live image streaming data is capable of instantly in-sight exhibiting an intact/defective appearance of the specific physical good, the live image streaming data also could lead the distant consumer to be instantly aware of an interest level in the specific physical good, a transaction price variation of the specific physical good, and an inventory quantity of the specific physical good, thereby raising the distant consumer's judgement, based on instant in-sight authenticity/assurance, for the specific physical good, and raising the distant consumer's confidence level of respective E-commerce transactions; (2) the built-up hardware costs or the maintaining/updating cost that are incurred in building up the webpage content by themselves could be avoided or lowered; (3) in the real-time transaction and marketing management system and the method for performing the same, according to the present invention, the remote webserver (as a transaction-processing backstage) is employed to completely accomplish an electronized management for operation and marketing steps, good information and the client data, for those existing physical-trading places. It is capable of instantly, directly and efficiently carrying out click-and-mortar transactions, to avoid multilevel distributors (e.g. a wholesale distributor and/or an intermediary distributor), which appear in between both the purchaser terminals and vendor terminals, joining their limited profit sharing. Consequently, the profits of the vendor terminals and the benefits of the purchaser terminals all can be raised; and simultaneously; (4) in the real-time transaction and marketing management system and the method for performing the same, according to the present invention, at least one image-capturing device is employed to capture a live image streaming data of a physical-trading place where a specific physical good is being exhibited, thereby enabling a purchaser/vendor terminal displaying unit to display a dedicated managing webpage thereon which contains an instant physical-trading scene constructed of the live image streaming data. The instant physical-trading scene in-sight stream-renders the corresponding physical-trading place, the specific physical good and a number of icons, by a way that the icons are inserted into the instant physical-trading scene and pointed to the specific physical good. The icons are respectively indicative of a number of marketing information relevant to the specific physical good contained within the live image streaming data. The relevant marketing information includes price information relevant to the specific physical good. The icons comprise an immediate checkout icon click-linked to a checkout modular, and a webpage-skipping icon click-linked to another webpage, which specifies other marketing information relevant to the specific physical good. Therefore, the inserted icons are capable of readily simplifying respective operation steps of E-commerce transaction of the specific social network platform, thereby facilitating a deal-making rate being raised for respective transactions.

### DESCRIPTION OF THE DIAGRAMS

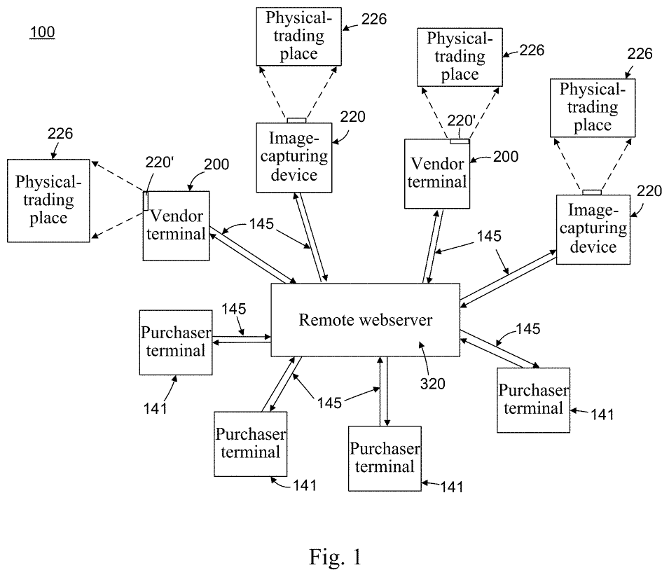

FIG. 1 depicts a structural scheme diagram of a real-time transaction and marketing management system according to a preferred embodiment of the present invention;

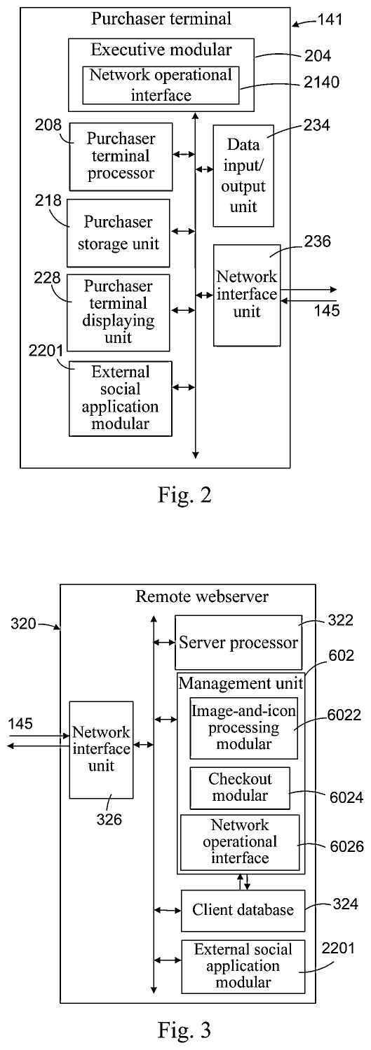

FIG. 2 depicts a detailed structural scheme diagram of a purchaser terminal in the real-time transaction and marketing management system depicted in FIG. 1;

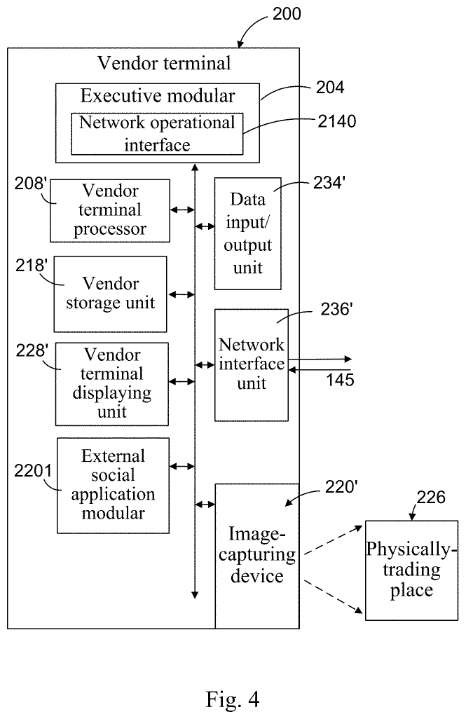

FIG. 3 depicts a detailed structural scheme diagram of a remote webserver in the real-time transaction and marketing management system;

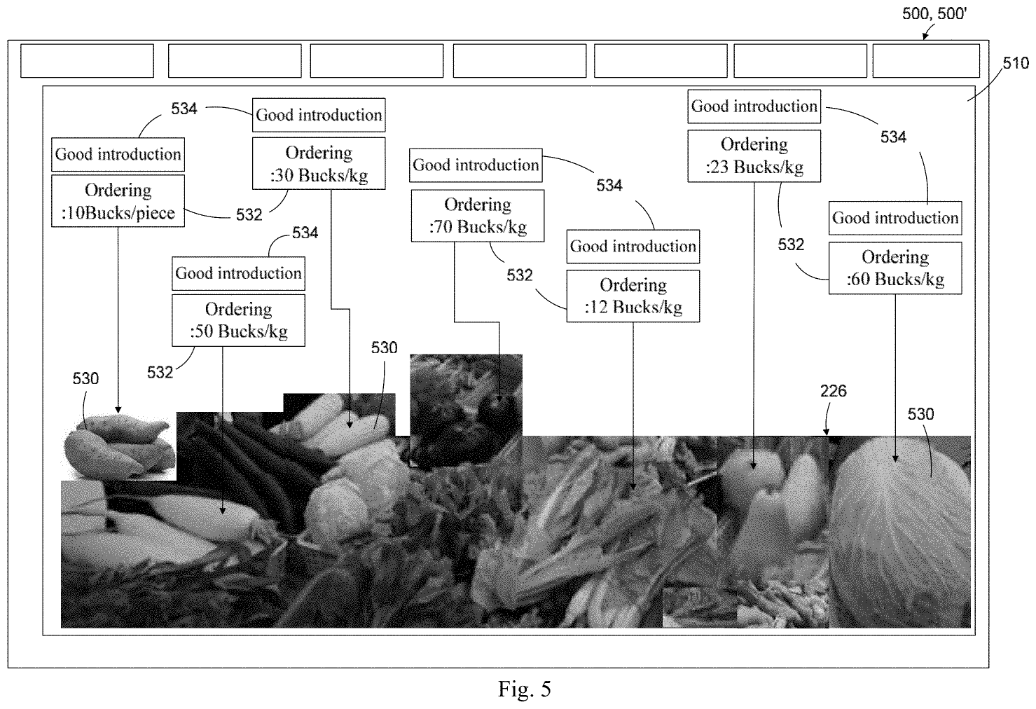

FIG. 4 depicts a detailed structural scheme diagram according to a vendor terminal in the real-time transaction and marketing management system depicted in FIG. 1;

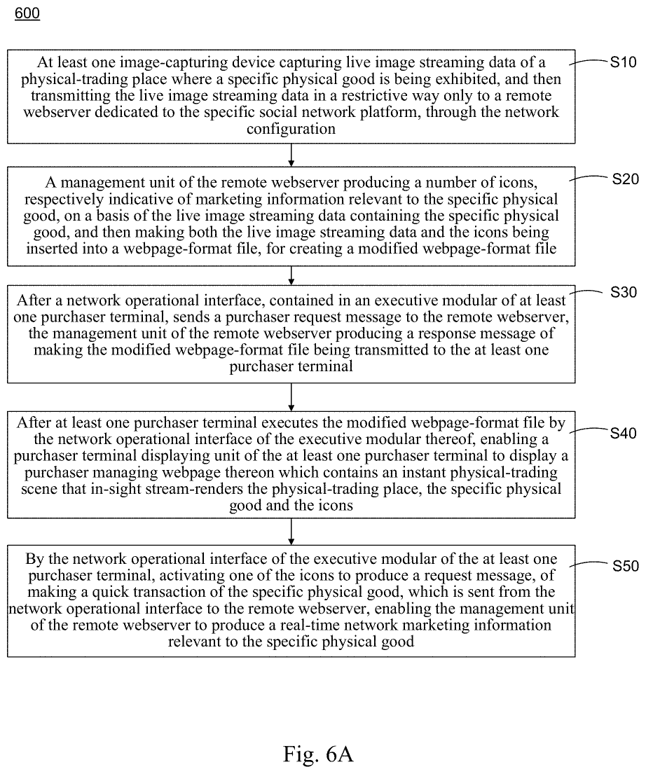

FIG. 5 depicts a schematic diagram of a purchaser managing webpage produced by the real-time transaction and marketing management system depicted in FIG. 1, wherein the purchaser managing webpage contains or is embedded within an image of an instant physical-trading scene;

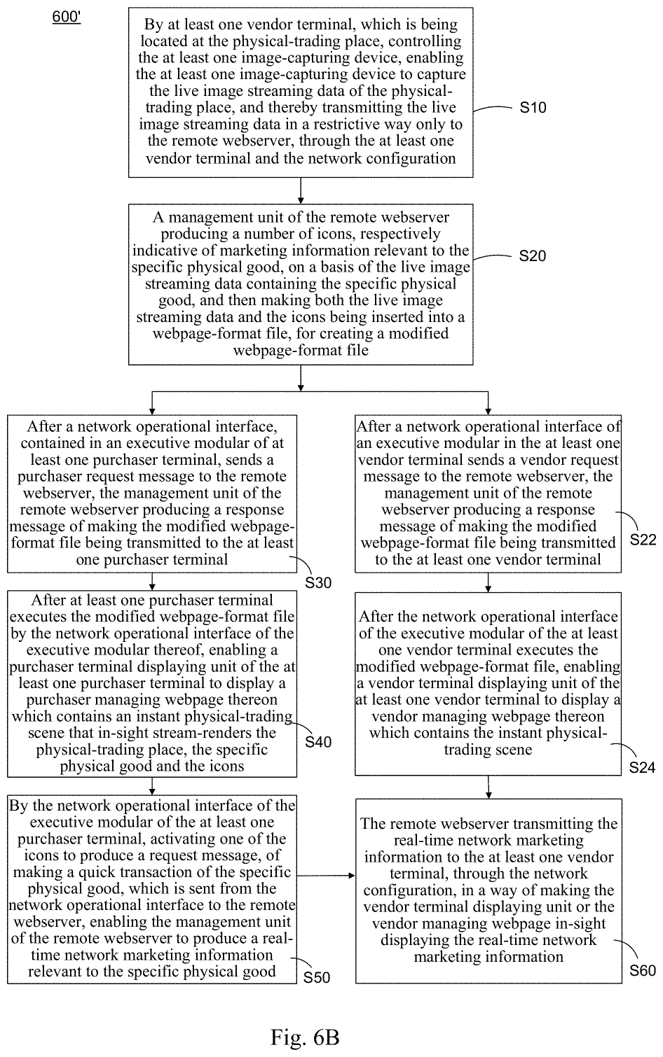

FIG. 6A depicts a flowchart diagram of a real-time transaction and marketing management method according to a preferred embodiment of the present invention; and

FIG. 6B depicts a flowchart diagram of a real-time transaction and marketing management method according to another preferred embodiment of the present invention.

### DETAILED DESCRIPTION OF THE PREFERRED EMBODIMENTS

The technical proposals in the embodiments of the present invention will be clearly and completely described in the following with reference to the accompanying drawings of the embodiments of the present invention. The directional terms mentioned in the present invention, such as “external”, “internal”, “before”, “after”, “outside”, “inside”, etc., are merely illustrative the direction of the drawing. Therefore, the directional terminology used is for the purpose of illustration and understanding of the invention, which is not intended to limit the invention.

First of all, please refer to FIG. 1, which depicts a structural scheme diagram of a real-time transaction and marketing management system 100 according to a preferred embodiment of the present invention. The real-time transaction and marketing management system 100 is configured to use with a specific social network platform and a network configuration 145 electronically linked to the specific social network platform. In the present preferred embodiment, the network configuration 145 comprises but is not limited to, one or combination of telecommunications networks, local area networks, and the internet network.

In the present preferred embodiment depicted in FIGS. 1, 2 and 3, the real-time transaction and marketing management system 100 is primarily constructed of: a number of purchaser terminals 141, a number of image-capturing devices 220, and a remote webserver 320 dedicated to the specific social network platform. In the present preferred embodiment depicted in FIG. 1, each of the image-capturing devices 220 could be any one kind of those existing electronic products, which has a photographing, and/or an image-shooting function, such as a known picture camera or video camera. The respective image-capturing device 220 for capturing image is dedicatedly disposed inside/beside corresponding one of a number of physical-trading places 226 (including but not limited to, for example, one of traditional markets, farmers' marketplace, brick-and-mortar stores, warehouses, orchards, tea plantations, rangelands, ranches, factories, market stalls and so forth), all which have existed. Furthermore, the respective image-capturing device 220 is employed to shoot a plurality of or a single specific physical good(s), such as an agricultural production, a livestock breeding production, a processing/handicraft good, ornament, various kinds of artificial production and so forth, which is/are being exhibited at the corresponding physical-trading place 226. In the present preferred embodiment, implementation of the respective image-capturing device 220 is distantly controlled by the remote webserver 320 through the network configuration 145, thereby periodically or irregularly capturing a live image streaming data of an image of the corresponding physical-trading place 226 (for correspondingly constituting an instant physical-trading scene) containing the specific physical good, from the corresponding physical-trading place 226. Then, the respective image-capturing device 220 transmits the captured live image streaming data in a restrictive way only to the remote webserver 320, through the network configuration 145, for further image-processing thereof. In the present preferred embodiment, the purchaser terminals 141 and the image-capturing devices 220 all are plural in quantity such that the physical-trading places 226 where the plural image-capturing devices 220 respectively capture images are plural different physical-trading places 226. However, it is not therefore limited to the respective quantity of both the purchaser terminals 141 and the image-capturing devices 220. That is because in other cases the respective quantity of both the purchaser terminal 141 and the image-capturing device 220 both could be only one.

In another application according to the present preferred embodiment depicted in FIG. 1, the other kind of image-capturing devices 220′ are respectively equipped within a number of vendor terminals 200 and respectively controlled by the vendor terminals 200, to respectively capture the live image streaming data of the corresponding physical-trading places 226, which are exhibiting their specific physical goods, individually. Next, the respective vendor terminal 200 would transmit the captured live image streaming data in a restrictive way only to the remote webserver 320, through the network configuration 145, for further image-processing thereof. The purchaser terminals 141 and the vendor terminals 200 could be but not limited to any one of a handheld/portable/wearable computing device, a smartphone, a computer, a laptop, a tablet and a computerized device. Its relevant detail structure would be detailed later. Based on different demands, the respective purchaser terminals 141, the respective image-capturing devices 220, and the respective vendor terminals 200 all could be, synchronously or asynchronously, electronically connected to the remote webserver 320 dedicated to the specific social network platform, through the network configuration 145. This could make the real-time transaction and marketing management system 100 running in a synchronously multitasking capability, to afford various kinds of service tasks for every node thereof, e.g. the purchaser terminals 141, the vendor terminals 200, or the remote webserver 320. Actually, in the present preferred embodiment depicted in FIG. 1, the running of the real-time transaction and marketing management system 100 needs treating the remote webserver 320 as a center node of the system 100, through the network configuration 145. The remote webserver 320 is respectively network-connected to the respective purchaser terminals 141, the respective vendor terminals 200 and the respective image-capturing devices 220 (its network topology diagram likes a “star” or “radial” shape). Briefly, in the system 100, the respective purchaser terminals 141 all are prohibited from directly transmitting image to or information-communicating with the image-capturing devices 220 or the vendor terminals 200, but all firstly need to only access the remote webserver 320 dedicated to the specific social network platform, for further task-serving only by through the remote webserver 320.

Further referring to an illustration depicted in FIGS. 1&3, the remote webserver 320, dedicated to the specific social network platform, primarily comprises a server processor 322, a network interface unit 326, a client database 324, a management unit 602, a server displaying unit (not shown) and an external social application modular 2201. In the present preferred embodiment depicted in FIG. 3, the management unit 602 of the remote webserver 320 could be realized but not limited to, as a network application program, which is configured to receive several conform ing-HTTP request messages transmitted from the respective purchaser terminals 141 and/or the respective vendor terminals 200, and to dedicatedly produce and send each managing webpage, in conformity with a HTML format and dedication to the specific social network platform, for the respective purchaser terminals 141 and/or the respective vendor terminals 200. In the preferred embodiment shown in FIG. 3, the management unit 602 further comprises an image-and-icon processing modular 6022, a checkout modular 6024 and a network operational interface 6026. The image-and-icon processing modular 6022, namely program codes, of the management unit 602 is configured to correspondingly produce/update a number of icons 532, 534 (as referring to the numerical signs 532, 534 in FIG. 5), which are respectively indicative of marketing information relevant to the specific physical goods, on a basis of the live image streaming data containing the specific physical goods and transmitted from the respective image-capturing devices 220 or vendor terminals 200. Next, by implementation of the image-and-icon processing modular 6022, the live image streaming data and the icons 532, 534 (see FIG. 5) both are inserted into a webpage-format file, in a way of creating a modified webpage-format file to be saved within the client database 324.

Further referring to the illustration depicted in FIGS. 1-3, the respective purchaser terminals 141 are electronically connected respectively to the remote webserver 320 through the network configuration 145, each of which has a purchaser terminal processor 208, a purchaser storage unit 218, a data input/output unit 234, a network interface unit 236, an executive modular 204 containing a network operational interface 2140, a purchaser terminal displaying unit 228 and an external social application modular 2201. In the present preferred embodiment depicted in FIG. 2, the executive modular 204 of the respective purchaser terminals 141 can be realized as a downloaded application program (as so-called “APP”) dedicated for the specific social network platform. In a practical application as the illustration depicted in FIGS. 1-3, after the network operational interface 2140 of the executive modular 204 of at least one of the purchaser terminals 141 sends a purchaser request message to the remote webserver 320, the management unit 602 of the remote webserver 320 produces a response message of making the modified webpage-format file being transmitted to the at least one purchaser terminal 141, on a basis of an “URL” (namely an “Uniform Resource Locator”) of the at least one purchaser terminal 141, such that then the at least one purchaser terminal 141 would execute the modified webpage-format file by the network operational interface 2140 of the executive modular 204. Certainly, the purchaser terminals 141 for synchronously sending their purchaser request messages to the remote webserver 320 are not limited in a quantity thereof. In a case, before sending the purchaser request message, the at least one purchaser terminal 141 need to input its dedicated-to-purchaser access information, from its data input/output unit 234, which would be treated as a security identification basis (such as a security account and/or passwords dedicated for the respective purchaser terminal 141) by the network operational interface 2140 of the executive modular 204, namely that the executive modular 204 of the at least one purchaser terminal 141 would send its dedicated-to-purchaser access information back to the remote webserver 320 for security identification, such that then the management unit 602 of the remote webserver 320 would determine whether to or not to admit the at least one purchaser terminal 141 accessing the remote webserver 320, for achieving the modified webpage-format file to execute, from the client database 324 of the remote webserver 320. However, the security identification basis/approach is not therefore limited to the above-mentioned case.

Further referring to another illustration depicted in FIGS. 1-4, the respective vendor terminals 200 are distributively located at the corresponding physical-trading places 226 and all electronically connected to the remote webserver 320 through the network configuration 145. And, the respective vendor terminal 200 has a vendor terminal processor 208′, a vendor storage unit 218′, a data input/output unit 234′, the executive modular 204 which is the same as equipped within the respective purchaser terminal 141 and also contains the aforementioned network operational interface 2140, a vendor terminal displaying unit 228′, a network interface unit 236′, an external social application modular 2201 and the image-capturing device 220′. The vendor terminal processor 208′ is configured to control and coordinate various tasks of the aforementioned respective components. As depicted in FIGS. 3 and 4, the image-capturing device 220′ of corresponding one of the vendor terminals 200 is used to capture an image from the corresponding physical-trading place 226 and therefore to produce the corresponding live image streaming data of the corresponding physical-trading place 226, by way of controlling of the executive modular 204 of the corresponding vendor terminal 200. Then, the image-capturing device 220′/the corresponding vendor terminal 200 makes the corresponding live image streaming data being transmitted to the image-and-icon processing modular 6022 of the remote webserver 320, through the corresponding vendor terminal 200 and the network configuration 145, for further image/information processing. In another aspect, after the network operational interface 2140 of the executive modular 204 of at least one of the vendor terminals 200 sends a vendor request message to the remote webserver 320, the management unit 602 of the remote webserver 320 produces a response message of making the modified webpage-format file being transmitted to the at least one vendor terminal 200, on a basis of an “URL” of the at least one vendor terminal 200, such that then the at least one vendor terminal 200 could execute the modified webpage-format file by the network operational interface 2140 of the executive modular 204 of the at least one vendor terminal 200. In a case, before sending the vendor request message, the at least one vendor terminal 200 needs to input a dedicated-to-vendor access information, from the data input/output unit 234′, which is treated as a security identification basis (such as a security account and/or passwords dedicated for the respective vendor terminals 200) by the network operational interface 2140 of the executive modular 204 of the at least one vendor terminal 200, namely that the executive modular 204 of the at least one vendor terminal 200 would send the dedicated-to-vendor access information back to the remote webserver 320 for security identification. Then, the management unit 602 of the remote webserver 320 would determine whether to or not to admit the at least one vendor terminal 200 accessing the remote webserver 320 to execute, for achieving the modified webpage-format file from the client database 324 of the remote webserver 320. However, the security identification basis/approach is not therefore limited to the above-mentioned case. It should be noted that, according to a difference between both the dedicated-to-purchaser access information and the dedicated-to-vendor access information, the modified webpage-format files that are achieved respectively by both the vendor terminals 200 and the vendor terminals 141 would be also different from each other. That is because of a purpose of producing individually dedicated function.

Further referring to the illustrations depicted in FIGS. 2-5. The purchaser terminal displaying unit 228 and the vendor terminal displaying unit 228′ both are an existing image monitor for visibly displaying images. The images include but are limited to: an image relative to an instant physical-trading scene 510 constructed of the live image streaming data, and other images relative to the managing webpages 500, 500′ (detailed later) containing the instant physical-trading scene 510, which are produced by utilization of the corresponding modified webpage-format files. In the present preferred embodiment according to the present invention, the instant physical-trading scene 510 comprises at least one frame that renders a physical trade being face-to-face carried out in persons. The network operational interfaces 2140, 6026 could be realized as a network browser dedicated for the specific social network platform, or any one of those existing external network browsers (such as Chrome, IE, Firefox and so forth) that can be activated to link up through the specific social network platform. The network operational interfaces 2140, 6026 are respectively configured to in-sight displays the images of the managing webpages 500, 500′ containing the instant physical-trading scene 510. The data input/output units 234, 234′ could be one or a combination of a mouse, a keyboard, and a biometrics device. The network interface units 236, 236′, 326 could be realized as a wired or wireless network interface (or “port”), which are configured for physical connection with the network configuration 145, thereby sending the corresponding messages respectively input from the purchaser terminals 141 and/or the vendor terminals 200 to the remote server 320, and vice versa. The external social application modular 2201 could be an application program (“APP”) downloaded from any one of those existing social networks (such as “FACEBOOK”, “LINE”, “TWITTER”, “GOOGLE+”, “WhatsApp”, “WeChat” and so forth), for being activated to link up with the network operational interfaces 2140, 6026. Thus, various external services provided from the external social application modular 2201 could be achieved by way of online-communications with the remote webserver 320 through the network configuration 145. For example, either of the respective purchaser terminal 141 and the respective vendor terminal 200 carries out online-communications with the remote webserver 320, or the purchaser terminal 141 carries out online-communications with the corresponding vendor terminal 200 in a way only through the remote webserver 320. The purchaser storage unit 218 and the vendor storage unit 218′ could be a hard disk or flash memory, wherein the purchaser storage unit 218 is configured to save local information relative to the purchaser terminal 141, such as transaction or accounting information, online-communication data, the corresponding live image streaming data and so forth. The vendor storage unit 218′ is configured to save local information relative to the vendor terminal 200, such as transaction or accounting information, the corresponding live image streaming data, online-communication data, good price information or inventory information and so forth. In the present embodiment, the purchaser storage unit 218 and the vendor storage unit 218′ are also configured to respectively save other local information relative to online-communications between the executive modular 204 and the corresponding external social application modular 2201.

Further referring to FIGS. 1-3 and 5, after the management unit 602 of the remote webserver 320 admits the request message, for achieving the modified webpage-format file to execute, from the at least one purchaser terminal 141, the corresponding purchaser terminal displaying unit 228 would visibly display a purchaser managing webpage 500 thereon which contains the instant physical-trading scene 510. Alternatively, as the illustration depicted in FIGS. 1, 4&5, after the management unit 602 of the remote webserver 320 admits the request message, for achieving the modified webpage-format file to execute, from the at least one vendor terminal 200, the vendor terminal displaying unit 228′ would visibly display a vendor managing webpage 500′ thereon which contains the instant physical-trading scene 510. However, it is noted that, in other cases, based on a difference between both the dedicated-to-purchaser access information and the dedicated-to-vendor access information, the modified webpage-format files that are respectively achieved by the at least one vendor terminal 200 and the at least one purchaser terminal 141 would be also different from each other. That is because of the purpose of producing individually dedicated functions, which might make a few of content differences between both the vendor managing webpage 500′ and the purchaser managing webpage 500. For example, the vendor managing webpage 500′ does not render thereon a “checkout” key and/or an “ordering” key required for the purchaser managing webpage 500; or the purchaser managing webpage 500 does not render thereon a “marketing situation key” required for the vendor managing webpage 500′; or although the contents of both the managing webpages 500, 500′ are completely identical with each other in initial stage, next function webpages where both are individually linked are different from each other. Even so, the vendor managing webpage 500′ and the purchaser managing webpage 500 both would keep the identical instant physical-trading scene 510 with each other thereon.

As illustrated in FIGS. 1 and 5, an image of the instant physical-trading scene 510 contained or embedded within the purchaser managing webpage 500 is rendered. In practical, each image, captured from the corresponding physical-trading place 226 by the individual image-capturing device 220 or the image-capturing device 220′ of the respective vendor terminal 200, can be regarded as the instant physical-trading scene 510. In the illustrations as depicted in FIGS. 1 and 5, the image of the instant physical-trading scene 510 contained or embedded within the purchaser managing webpage 500 in-sight stream-renders the corresponding physical-trading place 226 (such as an existing physical-trading vegetable stall 226), and a number of specific physical goods 530 (e.g. cabbages, sweet potatoes, maize, white radishes and other kinds of vegetables) being exhibited in the corresponding physical-trading place 226, and a number of icons 532, 534 dedicatedly arranged for the respective specific physical goods 530, by a way that the icons 532, 534 are respectively inserted into the instant physical-trading scene 510 and pointed in directional lines to the respective specific physical goods 530 (e.g. the cabbages, sweet potatoes, maize, white radishes and other kinds of vegetables) which are being exhibited in the corresponding physical-trading place (i.e. the existing physical-trading vegetable stall) 226. Moreover, on the upside of the purchaser managing webpage 500, there are a number of other functional button keys dedicatedly displayed for the specific social network platform. In the present preferred embodiment, the dedicated icons 532, 534 for the respective specific physical good 530 comprise but are not limited to: a clickable immediate checkout icon 532, which is configured to be click-linked to the checkout modular 6024 of the remote webserver 320, for directly sending an order message for making transaction of the corresponding specific physical good 530, and a clickable webpage-skipping icon 534, which is configured to be click-linked to another webpage which specifies other marketing information relevant to the corresponding specific physical good 530. In a case, with relation to the corresponding specific physical good 530, instant inventory quantity data, a specification/detail introduction, delivery information and so forth are specified on the another webpage. The inserted icons 532, 534 are capable of readily simplifying respective operation steps of E-commerce transaction of the specific social network platform, thereby facilitating a deal-making rate being raised.

In a practical application depicted in FIG. 5, the icons 532, 534 respectively could be a “good introduction” key 534, an “ordering” key 532. In addition, a price per weight unit are displayed beneath and dedicatedly pointed to the respective specific physical good 530. Thus, the relevant marketing information respectively indicated in the icons 532, 534 could include price information dedicated for the respective specific physical good 530. For example, the price information of one of the specific physical goods 530 such as “maize”, is rendered in “30 bucks per kg”; however, this price information could be updated anytime by way of carrying out of the image-and-icon processing modular 6022 of the management unit 602 of the remote webserver 320, or by a way that the corresponding vendor terminal 200 firstly makes a communicate with the remote webserver 320 to request the carrying out of the image-and-icon processing modular 6022 of the management unit 602. The above approach is not only limited to updating of the price information but also could suit updating of the marketing information. In another preferred embodiment according to the present invention, the icons 532, 534 also could comprise an icon, which renders an inventory quantity data of the corresponding specific physical good 530, and/or the instant physical-trading scene 510 in-sight stream-renders a quantity of the corresponding specific physical good 530.

It should be noted herein that, at the same time while the respective image-capturing device 220, 220′ capture the corresponding live image streaming data from the corresponding physical-trading place 226, to be provided for any one of the purchaser terminals 141 (namely distant consumers) located at distant region, the instant physical-trading scene 510 of the corresponding physical-trading place 226, where a traditional physical trade is being face-to-face carried out in persons, is also broadcasted to the individual purchaser terminals 141, simultaneously for their watch and reference. As well known, frequently physical-trade of the physical-trading place 226 such as a brick-and-mortar store could bring certain credibility and reputation to the average consumers. Thus, at each time while the respective instant physical-trading scene 510 occurred in the corresponding physical-trading place 226 are all simultaneously broadcasted to the individual purchaser terminals 141 for watching, it could not only strengthen a confidence level of the corresponding physical-trading places 226 for the purchaser terminals 141, but also further makes the instant physical-trading scene 510 having following functions of: instantly in-sight exhibiting an intact/defective appearance of the specific physical good 530, rendering how the level of other local consumers, who are being located at the corresponding physical-trading place 226 to carry out a traditionally physical trade, are interested in the specific physical good 530, and the transaction price variances and/or the inventory quantity variances for the respective specific physical goods 530. Accordingly, it could not raise only the instant in-sight authenticity/assurance of the purchaser terminals 141 for the specific physical goods 530 but also could inherently raise the confidence level of the distant consumers for the respective E-commerce transactions with the respective physical-trading place 226 (such as a brick-and-mortar store) through the specific social network platform.

Please further refer to the illustration depicted in FIGS. 2-5. By the network operational interface 2140 of the executive modular 204 of one of the purchaser terminals 141, one of the icons 532, 534 (e.g. the “ordering” key 532) on the purchaser managing webpage 500 is activated to produce a request message, of making a quick transaction of the specific physical good 530, which is sent from the network operational interface 2140 to the remote webserver 320. Then, the management unit 602 of the remote webserver 320 is therefore enabled to produce a real-time network marketing information relevant to the specific physical good 530, and then to make the real-time network marketing information being saved within the client database 324, in a way of corresponding to the relevant marketing information that are respectively indicative in the icons 532, 534. After the remote webserver 320 produces the real-time network marketing information, the remote webserver 320 further makes the real-time network marketing information being fed back to the corresponding vendor terminal 200, thereby making the vendor terminal displaying unit 228′ or the vendor managing webpage 500′ in-sight displaying the real-time network marketing information. Moreover, the real-time network marketing information is further saved within the vendor storage unit 218′, to be treated as one of operating parameters for the corresponding vendor terminal 200.

In another aspect, as shown in FIGS. 4 and 5, after any one of the vendor terminals 200 correspondingly produces a real-time physical-marketing information, dependent on a real-time physical-marketing situation of the specific physical good 530 at the corresponding physical-trading place 226 (in a case that the local consumer is carrying out a traditionally physical trade at the corresponding physical-trading place 226 for the specific physical good 530), in order to make the real-time physical-marketing information being treated as one of the operating parameters and being transmitted to the remote webserver 320 through the network configuration 145. Then, the remote webserver 320 would update the relevant marketing information, which are respectively indicated in the icons 532, 534, on a basis of the real-time physical-marketing information and/or the real-time network marketing information, and thereby correspondingly update the modified webpage-format file, toward a way of completely accomplishing electronized management for operation and marketing steps, good information and the client data, for those existing physical-trading places 226. Thus, it is capable of instantly, directly and efficiently carrying out various click-and-mortar transactions (with an integration of both the real-time physical-marketing information and the real-time network marketing information), in order to avoid multilevel distributors (e.g. a wholesale distributor and/or an intermediary distributor), which might appear in between both of the respective purchaser terminals 141 and the respective vendor terminals 200, joining their limited profit sharing. Consequently, the profits of the respective vendor terminals 200 and the benefit of the respective purchaser terminals 141 both could be raised. Furthermore, the real-time physical-marketing information and the real-time network marketing information both could be treated as the operating parameters required for the data processing or operating of the respective vendor terminal 200. With utilization of the operating parameters, the respective vendor terminal 200 is capable of adjusting and controlling the price information and/or the marketing information relative to the specific physical good, through the remote webserver 320, for accomplishing a management objective of electronized operation.

Besides, please further refer to an illustration depicted in FIG. 6A, where a flowchart diagram of a real-time transaction and marketing management method 600, according to a preferred embodiment of the present invention, is introduced. Since the real-time transaction and marketing management method 600 is a method for performing the real-time transaction and marketing management system 100 depicted in FIGS. 1-5, which is configured to use with a specific social network platform linked to a network configuration 145. Hence, in the real-time transaction and marketing management method 600, various components and their functions mentioned all can be referred to the above descriptions for the real-time transaction and marketing management system 100 depicted in FIGS. 1-5, and therefore would be omitted in detail later. The real-time transaction and marketing management method 600 comprises:

implementing a step S10 which comprises: at least one image-capturing device capturing live image streaming data of a physical-trading place where a specific physical good is being exhibited, and then transmitting the live image streaming data in a restrictive way only to a remote webserver dedicated to the specific social network platform, through the network configuration;

next, implementing a step S20 which comprises: a management unit of the remote webserver producing a number of icons, respectively indicative of marketing information relevant to the specific physical good, on a basis of the live image streaming data containing the specific physical good, and then making both the live image streaming data and the icons being inserted into a webpage-format file, in a way of creating a modified webpage-format file to be saved within a client database of the remote webserver;

next, implementing a step S30 which comprises: after a network operational interface, contained in an executive modular of at least one purchaser terminal, sends a purchaser request message to the remote webserver, the management unit of the remote webserver producing a response message of making the modified webpage-format file being transmitted to the at least one purchaser terminal, on a basis of an “URL” of the at least one purchaser terminal;

next, implementing a step S40 which comprises: after at least one purchaser terminal executes the modified webpage-format file by the network operational interface of the executive modular thereof (for example, on a basis of an access information dedicated for entry of the at least one purchaser terminal), enabling a purchaser terminal displaying unit of the at least one purchaser terminal to display a purchaser managing webpage thereon which contains an instant physical-trading scene constructed of the live image streaming data, wherein the instant physical-trading scene in-sight stream-renders the corresponding physical-trading place, the specific physical good and the icons, by a way that the icons are inserted into the instant physical-trading scene and pointed in directional lines to the specific physical good; in the present preferred embodiment, the instant physical-trading scene comprises at least one frame of rendering a physical trade which is being face-to-face carried out in persons; and

next, implementing a step 50 which comprises: by the network operational interface of the executive modular of the at least one purchaser terminal, activating one of the icons to produce a request message, of making a quick transaction of the specific physical good, which is sent from the network operational interface to the remote webserver, enabling the management unit of the remote webserver to produce a real-time network marketing information relevant to the specific physical good, and then making the real-time network marketing information being saved, within the client database of the remote webserver, in a way of corresponding to the relevant marketing information which are respectively indicative in the icons.

Furthermore, a flowchart diagram of a real-time transaction and marketing management method 600′ according to another preferred embodiment of the present invention is introduced as depicted in FIG. 6B. The real-time transaction and marketing management method 600′ can be another exemplary method, which is applied, with usage of the real-time transaction and marketing management system 100 depicted in FIGS. 1-5, for a specific social network platform having the remote server 320 and linked to a network configuration 145. In the real-time transaction and marketing management method 600′, various components and their functions mentioned all can be referred to the above descriptions of the real-time transaction and marketing management system 100 depicted in FIGS. 1-5, and therefore would be omitted in detail below. In comparison, the real-time transaction and marketing management method 600′ depicted in FIG. 6B has the same steps S10-S50 as afore-mentioned in the method 600 depicted in FIG. 6A. Beside that, from the real-time transaction and marketing management method 600 in FIG. 6A, the real-time transaction and marketing management method 600′ depicted in FIG. 6B further has the following distinctions in step comprising:

between the aforementioned steps S10-S20, further implementing a step which comprises: by at least one vendor terminal, which is being located at the physical-trading place, controlling the at least one image-capturing device, enabling the at least one image-capturing device to capture the live image streaming data of the physical-trading place where the specific physical good is being exhibited, and thereby transmitting the live image streaming data in a restrictive way only to the remote webserver, through the at least one vendor terminal and the network configuration;

after the step S20, next implementing a step S22 which comprises: after a network operational interface of an executive modular (e.g. as same as the same network operational interface of the same executive modular of the at least one purchaser terminal) disposed in the at least one vendor terminal sends a vendor request message to the remote webserver, the management unit of the remote webserver producing a response message of making the modified webpage-format file being transmitted to the at least one vendor terminal, on a basis of an “URL” of the at least one vendor terminal;

next, implementing a step S24 which comprises: after the network operational interface of the executive modular of the at least one vendor terminal executes the modified webpage-format file (for example, on a basis of an access information dedicated for entry of the at least one vendor terminal), enabling a vendor terminal displaying unit of the at least one vendor terminal to display a vendor managing webpage thereon which contains the instant physical-trading scene; and

after the step S50 (namely that after the remote webserver produces the real-time network marketing information), next implementing a step S60 which comprises: the remote webserver transmitting the real-time network marketing information to the at least one vendor terminal, through the network configuration, in a way of making the vendor terminal displaying unit or the vendor managing webpage in-sight displaying the real-time network marketing information which is treated as one of operating parameters required for the corresponding vendor terminal. According to the operating parameters, the corresponding vendor terminal is capable of adjusting and controlling price information and/or marketing information relative to the specific physical good, through the remote webserver, thereby accomplishing a management objective of electronized operation; in another embodiment, the step S60 further comprises: by the at least one vendor terminal producing a real-time physical-marketing information, dependent on a real-time physical-marketing situation of the specific physical good at the physical-trading place, and then making the real-time physical-marketing information being treated as one of operating parameters and being transmitted to the remote webserver through the network configuration, the remote webserver updating the relevant marketing information, which are respectively indicative in the icons, on a basis of the real-time physical-marketing information and/or the real-time network marketing information, thereby correspondingly updating the modified webpage-format file. Therefore, the real-time transaction and marketing management method 600′ according to the present invention, is capable of accomplishing an electronized management, operation and marketing steps, good information and the client data, for those existing physical-trading places 226 depicted in FIG. 1, and click-and-mortar transactions (with an integration of both the real-time physical-marketing information and the real-time network marketing information). Furthermore, the real-time physical-marketing information and the real-time network marketing information both can be treated as the operating parameters required for the data processing and/or operation of the corresponding vendor terminal. According to the operating parameters, the corresponding vendor terminal is capable of adjusting and controlling the price information and/or marketing information relative to the specific physical good, through the remote webserver, for accomplishing the management objective of electronized operation thereof.

In conclusion, the present invention brings the following beneficial effects that: (1) in comparison with the prior arts, the real-time transaction and marketing management system and the method for the same, according to the present invention, can integrate both of an instant high efficiency of the virtual E-commerce transaction and higher authenticity/assurance functions provided from those existing physical-trading places. This could afford an accurately estimating basis and a higher confidence level before the distant consumers send an online order, thereby effectively avoiding scams, delivery delay, expired goods, or the aforementioned risk issues incurred in these prior arts, for example, including but not limited to, a physical good that the consumer acquires having differences from an online-marketing good that the same consumer online-orders, a physical good that the consumer acquires having defects, receiving an insufficient-inventory notice after the consumer sends an order, and so forth. According to the present invention, the instant physical-trading scenes constructed of live image streaming data, image-captured from those existing physical-trading places (such as traditional markets, farmers' marketplace, brick-and-mortar stores, warehouses, orchards, tea plantations, rangelands, ranches, factories, market stalls and so forth) could be instantly provided for at least one purchaser terminal (namely a distant consumer) which is located at a distant region. With utilization of the live image streaming data, such an instant physical-trading scene could concretely render a physical trade which is being face-to-face carried out in persons at an existing physical-trading place, and also could be simultaneously broadcasted to the at least one purchaser terminal for his/her watch and reference. In addition that the live image streaming data is capable of instantly in-sight exhibiting an intact/defective appearance of the specific physical good, the live image streaming data also could lead the distant consumer to be instantly aware of an interest level in the specific physical good, a transaction price variation of the specific physical good, and an inventory quantity of the specific physical good, thereby raising the distant consumer's judgement, based on instant in-sight authenticity/assurance, for the specific physical good, and raising the distant consumer's confidence level of respective E-commerce transactions; (2) the real-time transaction and marketing management system and the method for the same, according to the present invention, the specific social network platform is configured to provide those existing physical-trading places with spreads of their new customers and business opportunities, but without need of extra building up their E-commerce transaction platforms by themselves. Therefore, the built-up hardware costs or the maintaining/updating cost, which are incurred in building up the webpage content by themselves, can be avoided or decreased; (3) in the real-time transaction and marketing management system and the method for performing the same, according to the present invention, the remote webserver (as a transaction-processing backstage) is employed to completely accomplish an electronized management for operation and marketing steps, good information and the client data, for those existing physical-trading places. It is capable of instantly, directly and efficiently carrying out click-and-mortar transactions, to avoid multilevel distributors (e.g. a wholesale distributor and/or an intermediary distributor), which appear in between both the purchaser terminals and vendor terminals, joining their limited profit sharing. Consequently, the profits of the vendor terminals and the benefits of the purchaser terminals all can be raised; and simultaneously, (4) in the real-time transaction and marketing management system and the method for performing the same, according to the present invention, at least one image-capturing device is employed to capture a live image streaming data of a physical-trading place where a specific physical good is being exhibited, thereby enabling a purchaser/vendor terminal displaying unit to display a dedicated managing webpage thereon which contains an instant physical-trading scene constructed of the live image streaming data. The instant physical-trading scene in-sight stream-renders the corresponding physical-trading place, the specific physical good and a number of icons, by a way that the icons are inserted into the instant physical-trading scene and pointed to the specific physical good. The icons are respectively indicative of the marketing information relevant to the specific physical good contained within the live image streaming data. The relevant marketing information includes price information relevant to the specific physical good. In addition, the icons comprise an immediate checkout icon click-linked to a checkout modular, and a webpage-skipping icon click-linked to another webpage, which specifies other marketing information relevant to the specific physical good. Therefore, the inserted icons are capable of readily simplifying respective operation steps of E-commerce transaction of the specific social network platform, thereby facilitating a deal-making rate being raised.

As described above, although the present invention has been described with the preferred embodiments thereof, those skilled in the art will appreciate that various modifications, additions, and substitutions are possible without departing from the scope and the spirit of the invention. Accordingly, the scope of the present invention is intended to be defined only by reference to the claims.

What is claimed is:

1. A real-time transaction and marketing management system, configured to use with a specific social network platform linked to a network configuration, comprising:
a remote webserver dedicated to the specific social network platform, having a server processor, a management unit and a client database;
at least one purchaser terminal electronically connected to the remote webserver through the network configuration and having a purchaser terminal processor, an executive modular dedicated to the specific social network platform and providing a network operational interface, and a purchaser terminal displaying unit; and
at least one image-capturing device capturing live image streaming data of a physical-trading place where a specific physical good is being exhibited, and then transmitting the live image streaming data in a restrictive way only to the remote webserver through the network configuration; wherein
the management unit of the remote webserver produces a number of icons, respectively indicative of marketing information relevant to the specific physical good, on a basis of the live image streaming data containing the specific physical good, and then makes both the live image streaming data and the icons being inserted into a webpage-format file, in a way of creating a modified webpage-format file to be saved within the client database, wherein after the network operational interface of the executive modular of the at least one purchaser terminal sends a purchaser request message to the remote webserver, the management unit of the remote webserver produces a response message of making the modified webpage-format file being transmitted to the at least one purchaser terminal, and after the at least one purchaser terminal executes the modified webpage-format file by the network operational interface of the executive modular thereof, the purchaser terminal displaying unit is enabled to display a first managing webpage thereon which contains an instant physical-trading scene constructed of the live image streaming data and in-sight stream-rendering the corresponding physical-trading place, the specific physical good and the icons, by a way that the icons are inserted into the instant physical-trading scene and pointed to the specific physical good, and by the network operational interface of the executive modular of the at least one purchaser terminal, activating one of the icons to produce a request message, of making a quick transaction of the specific physical good, which is sent to the remote webserver, the management unit of the remote webserver is enabled to produce a real-time network marketing information relevant to the specific physical good, and then to make the real-time network marketing information being saved within the client database.

2. The real-time transaction and marketing management system according to claim 1, wherein the remote webserver launches a distant control on the at least one image-capturing device through the network configuration, thereby making the at least one image-capturing device producing the live image streaming data of the corresponding physical-trading place.

3. The real-time transaction and marketing management system according to claim 1, wherein after the at least one purchaser terminal executes the modified webpage-format file, on a basis of an access information dedicated for entry of the at least one purchaser terminal, by the network operational interface of the executive modular, the purchaser terminal displaying unit is enabled to display the first managing webpage thereon.

4. The real-time transaction and marketing management system according to claim 1, further comprising at least one vendor terminal which is located at the physical-trading place and electronically connected to the remote webserver through the network configuration, and the at least one vendor terminal has a vendor terminal processor, an executive modular, a vendor terminal displaying unit and the at least one image-capturing device, wherein by way of controlling of the executive modular of the at least one vendor terminal, the at least one image-capturing device captures the live image streaming data of the physical-trading place and then makes the live image streaming data being transmitted to the remote webserver through the at least one vendor terminal and the network configuration, and after the network operational interface of the executive modular of the at least one vendor terminal sends a vendor request message to the remote webserver, the management unit of the remote webserver produces a response message of making the modified webpage-format file being transmitted to the at least one vendor terminal, wherein after the network operational interface of the executive modular of the at least one vendor terminal executes the modified webpage-format file, the vendor terminal displaying unit is enabled to display a second managing webpage thereon which contains the instant physical-trading scene, and after the remote webserver produces the real-time network marketing information, the remote webserver transmits the real-time network marketing information to the at least one vendor terminal, in a way of making the vendor terminal displaying unit or the second managing webpage in-sight displaying the real-time network marketing information.

5. The real-time transaction and marketing management system according to claim 4, wherein after the network operational interface of the executive modular of the at least one vendor terminal executes the modified webpage-format file, on a basis of an access information dedicated for entry of the at least one vendor terminal, the vendor terminal displaying unit is enabled to display the second managing webpage thereon.

6. The real-time transaction and marketing management system according to claim 4, wherein the at least one vendor terminal produces a real-time physical-marketing information, dependent on a real-time physical-marketing situation of the specific physical good at the physical-trading place, to make the real-time physical-marketing information being transmitted to the remote webserver through the network configuration, in a way that the remote webserver updates the relevant marketing information, which are respectively indicative in the icons, on a basis of the real-time physical-marketing information and/or the real-time network marketing information, and thereby correspondingly updates the modified webpage-format file.

7. The real-time transaction and marketing management system according to claim 1, wherein the remote webserver further has an image-and-icon processing modular which is configured to produce/update the icons respectively indicative of the relevant marketing information for the specific physical good, and the relevant marketing information contains price information relevant to the specific physical good, and the icons comprise an immediate checkout icon click-linked to a checkout modular, and a webpage-skipping icon click-linked to another webpage which specifies other marketing information relevant to the specific physical good.

8. The real-time transaction and marketing management system according to claim 1, wherein the icons comprise an icon indicative of an inventory quantity of the specific physical good, and/or the instant physical-trading scene in-sight stream-renders a quantity of the specific physical good.

9. The real-time transaction and marketing management system according to claim 1, wherein the instant physical-trading scene comprises at least one frame that renders a physical trade being face-to-face carried out in persons.

10. A real-time transaction and marketing management method, applied with a specific social network platform linked to a network configuration, comprising:
at least one image-capturing device capturing live image streaming data of a physical-trading place where a specific physical good is being exhibited, and then transmitting the live image streaming data in a restrictive way only to a remote webserver dedicated to the specific social network platform, through the network configuration;
next, a management unit of the remote webserver producing a number of icons, respectively indicative of marketing information relevant to the specific physical good, on a basis of the live image streaming data containing the specific physical good, and then making both the live image streaming data and the icons being inserted into a webpage-format file, in a way of creating a modified webpage-format file to be saved within a client database of the remote webserver;
next, after a network operational interface, contained in an executive modular of at least one purchaser terminal, sends a purchaser request message to the remote webserver, the management unit of the remote webserver producing a response message of making the modified webpage-format file being transmitted to the at least one purchaser terminal;
next, after the at least one purchaser terminal executes the modified webpage-format file by the network operational interface of the executive modular thereof, enabling a purchaser terminal displaying unit of the at least one purchaser terminal to display a first managing webpage thereon which contains an instant physical-trading scene constructed of the live image streaming data and in-sight stream-rendering the corresponding physical-trading place, the specific physical good and the icons, by a way that the icons are inserted into the instant physical-trading scene and pointed to the specific physical good; and
next, by the network operational interface of the executive modular of the at least one purchaser terminal, activating one of the icons to produce a request message, of making a quick transaction of the specific physical good, which is sent to the remote webserver, enabling the management unit of the remote webserver to produce a real-time network marketing information relevant to the specific physical good, and then to make the real-time network marketing information being saved within the client database.

11. The real-time transaction and marketing management method according to claim 10, further comprising:
by at least one vendor terminal, which is located at the physical-trading place, controlling the at least one image-capturing device, enabling the at least one image-capturing device to capture the live image streaming data of the physical-trading place, and then to make the live image streaming data being transmitted to the remote webserver, through the at least one vendor terminal and the network configuration;
next, after a network operational interface of an executive modular disposed in the at least one vendor terminal sends a vendor request message to the remote webserver, the management unit of the remote webserver producing a response message of making the modified webpage-format file being transmitted to the at least one vendor terminal;
next, after the network operational interface of the executive modular of the at least one vendor terminal executes the modified webpage-format file, enabling a vendor terminal displaying unit of the at least one vendor terminal to display a second managing webpage thereon which contains the instant physical-trading scene; and
next, after the remote webserver produces the real-time network marketing information, the remote webserver transmitting the real-time network marketing information to the at least one vendor terminal, in a way of making the vendor terminal displaying unit or the second managing webpage in-sight displaying the real-time network marketing information thereon.

12. The real-time transaction and marketing management method according to claim 11, further comprising: by the at least one vendor terminal producing a real-time physical-marketing information, dependent on a real-time physical-marketing situation of the specific physical good at the physical-trading place, and then making the real-time physical-marketing information being transmitted to the remote webserver through the network configuration, the remote webserver updating the relevant marketing information, which are respectively indicative in the icons, on a basis of the real-time physical-marketing information and/or the real-time network marketing information, thereby further updating the modified webpage-format file.

13. The real-time transaction and marketing management method according to claim 10, wherein the instant physical-trading scene comprises at least one frame of rendering a physical trade that is being face-to-face carried out in persons.
